(19) United States
(12) Patent Application Publication
(10) Pub. No.: US 2016/0357909 A1
(43) Pub. Date: Dec. 8, 2016

(54) COMPUTERIZED SYSTEM AND METHOD FOR PRESENTING PAYER-BASED HEALTH RECORD DATA TO HEALTH CARE PROVIDERS

(71) Applicant: Humana Inc., Louisville, KY (US)

(72) Inventors: Christopher L. Northam, Louisville, KY (US); Patrick J. Murta, Louisville, KY (US)

(73) Assignee: HUMANA INC., Louisville, KY (US)

(21) Appl. No.: 13/893,972

(22) Filed: May 14, 2013

(51) Int. Cl. G06F 19/00

(52) U.S. Cl. CPC G06F 19/322

(57) ABSTRACT

A computerized system and method for presenting payer-based health record (PBHR) data to a health care provider is disclosed. In an example embodiment, the member summary data is organized on one or more summary pages that contain recent, concise, and relevant information regarding a member of an insurance plan for use by a health provider as a quick reference when care is delivered. In the computerized system and method, a member summary data aggregation process is executed to extract from a member's health profile and claim data relevant information for a member summary. The information contained in a member summary is derived in relation to specific categories. The member summary provides an integrated report of clinically-relevant member-specific medical data for use by a health care provider when care is delivered to the member.

### CROSS-REFERENCE TO RELATED APPLICATIONS

None.

### BACKGROUND OF THE INVENTION

The payer-based health record” (PBHR) provides extensive and detailed historical information for a patient based on medical, surgical, pharmacy, and behavioral health claims data, care management data, lab data and other clinical data as well as basic demographics found in enrollment data. PBHRs may also be used to calculate Healthcare Effectiveness Data and Information Set (HEDIS) measurements. HEDIS is a tool used by most health plans to measure performance on important dimensions of care and service. PBHRs typically provide more complete and comprehensive information about a patient's health status because they contain data from multiple health care providers over a long period of time. While a single health care provider has a record of patient disclosed information as well as the provider's own diagnoses, treatments, and prescriptions, he or she may not know what the patient has been told by other providers or what treatments have been initiated by others. In the case of a patient with serious, complex, and long-term health problems, tracking diagnoses, treatments, and medications from multiple care providers is crucial to managing the patient's health care regimen. PBHRs are particularly useful in serving the needs of very ill patients because they may provide information to a treating physician about a substantial portion of or the patient's entire medical history, tests, diagnoses, treatments, and prescriptions.

While collection and management of such claims and related health data is the primary responsibility of the payer, the information can be helpful to health care providers and individual patients in determining appropriate patient care. The data supports a common patient view that can be shared among parties thereby facilitating an individualized care plan that takes into account various aspects of a patient's total health. A comprehensive and complete patient view allows for better treatment decisions and improved outcomes.

Many health claims payers such as insurance companies allow health care providers to access PBHRs through web portals and other access channels. In many instances, the data that is accessible is “raw” claims data organized in chronological order. Such data is typically unedited and unorganized. The information may be complete but specific, important details may be difficult to find. It is simply “rolled up” and therefore, less valuable as a communication tool. Although PBHRs provide extensive and detailed information, many providers do not take advantage of the opportunity to access the records because the format and presentation of information is not conducive for a quick and summarized review of critical member information at the time of care.

There is a need for a computerized system and method for summarizing, organizing, and presenting PBHR data in manner that is clear and concise. There is a need for a computerized system and method for summarizing, organizing, and presenting PBHR in a format that makes the data useful as an effective diagnosis and treatment resource for health care providers. There is a need for a computerized system and method for presenting payer-based health record data in a format that is conducive for a quick and summarized review of critical member information at the time of care.

### SUMMARY OF THE INVENTION

The present disclosure is directed to a computerized system and method for presenting payer-based health record (PBHR) data to a health care provider. In an example embodiment, the member summary data is collected and organized on one or more summary pages that contain recent, concise, and relevant information regarding a member of an insurance plan for use by a health care provider as a quick reference when care is delivered. In the computerized system and method, a member summary data aggregation process is executed to extract from a member's health profile and claim data relevant information. The information contained in the member summary is derived in relation to specific categories. The member summary provides an integrated report of clinically-relevant member-specific medical data for use by a health care provider when care is delivered to the member. The member summary further allows the provider to focus on the most pertinent member information rolled up into a summarized format enabling improved clinical outcomes for members.

### BRIEF DESCRIPTION OF THE DRAWINGS

FIG. 1 is a block diagram of a computerized system for presenting selected PBHR data in a member summary according to an example embodiment;

FIGS. 2A-2C are sample member summary access screens for a payer provider portal according to an example embodiment;

FIGS. 3A and 3B are sample the member summary access screens for a payer partner portal according to an example embodiment;

FIG. 4 is a Medicare sample summary according to an example embodiment; and

FIG. 5 is a sample summary for members covered under a commercial plan according to an example embodiment.

### DETAILED DESCRIPTION

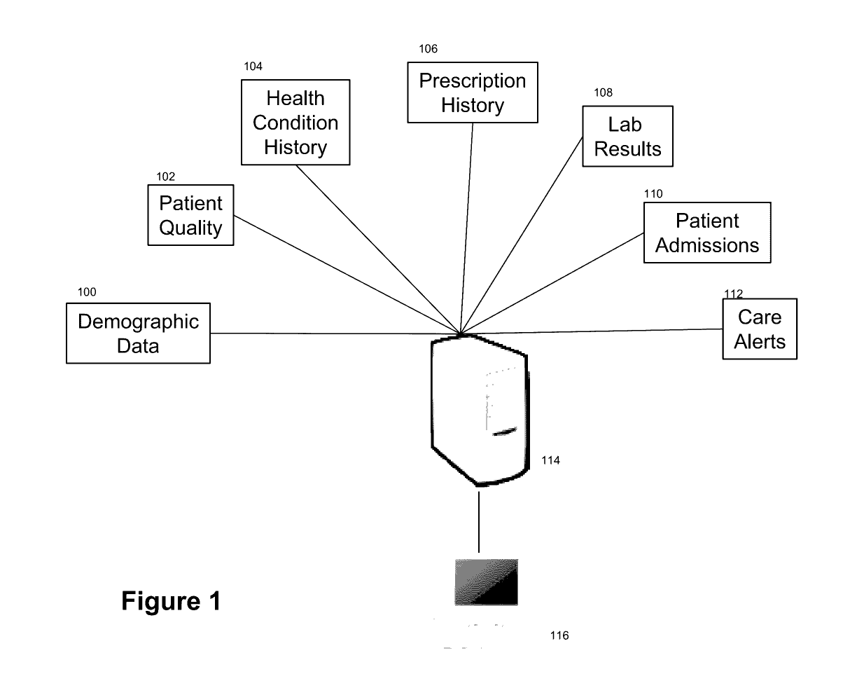

Referring to FIG. 1, a block diagram of a computerized system for presenting selected PBHR data according to an example embodiment is shown. The report data may be compiled by accessing one or more existing data sources that the health insurance company maintains and updates in connection with processing health care claims for its members. In an example embodiment, a member summary data aggregation process executing at a server 114 aggregates demographic data 100, patient quality data 102, health condition history data 104, prescription data 106, lab results data 108, patient admissions data 110, and care alerts 116 to prepare a member summary for a specified patient. The member summary is presented to a computer user 116 on demand.

In an example embodiment, the member summary is accessible from a provider portal operated by a health insurance company or insurance company partner. The report comprises clinically-relevant, member-specific medical data for use by a health care provider and may be accessed by the provider when care is delivered to the member at the provider's office or facility. To ensure ease of access to the member summary, a link to the summary is provided through an eligibility and benefits status screen. The provider may access the summary when verifying the member's eligibility and benefits during an office visit or a consultation. As a result, access to the member summary is integrated into the provider's practice workflow which typically involves an eligibility and benefit verification process during an office visit or a consultation. The consolidated member-specific report may be used by health care providers in preparation for and during their interactions with members. The member summary may be printed and placed in the member's chart/medical record or saved within an Electronic Medicare Record or Practice Management system for review and discussion between the provider and the member at the time of care.

In an example embodiment, the member summary comprises the following information:

TABLE 1
Member Summary Information

| Member Summary Section | Description |
|---|---|
| Member Demographic | Name, date of birth, sex, city/state, phone |
| Information | number, policy or plan member number, |
| | policy or plan type and identifier, policy |
| | or plan effective date, member's primary |
| | care provider name |
| Patient Quality | Medicare members |
| (Screening and Care | Measures reflected based on the National |
| Alerts) | Committee for Quality Assurance (NCQA)'s |
| | Healthcare Effectiveness Data and |
| | Information Set (HEDIS) |
| | HEDIS Star Measures for 2012 include 17 |
| | possible measures for females and 15 |
| | possible measures for males |
| | Compliance indicator of Y or N is based on |
| | screening frequency; review compliance date |
| | to verify if/when a HEDIS measure requires |
| | action; compliance date that test brought |
| | member into compliance |
| | Lag time of data: up to 90 days based on |
| | claims data |
| | Care Alerts: Medicare and Commercial |
| | Members |
| | Rolling 12-month care alert information for |
| | patient |
| | N indicates an opportunity to close a gap |
| | in care |
| | Gaps in care that are noncompliant are |
| | reflected |
| | Lag time of data: Information is refreshed |
| | every 24 hrs |
| Health Condition History | Medicare members |
| | Medicare Risk Adjustment information for |
| | the current plan year and the previous plan |
| | year, if available |
| | Chronic conditions may be displayed before |
| | acute conditions |
| | If current-year status is blank and condition |
| | is still present, consider documentation |
| | opportunity |
| | Lag time of data: up to seven days based on |
| | claims data |
| | Medicare and Commercial Members: |
| | Diagnosis Codes display with description |
| | code, type (Chronic or Acute), and Date |
| | of Service |
| Prescription History | Rolling 12-month prescription history for |
| | patient (date filled, drug name, dosage, days |
| | of supply, times filled, prescribing physician) |
| | Sensitive information may be excluded |
| | Lag time of data: near real-time |
| Lab Results | Rolling 12-month lab history for patient |
| | (lab test date, logical observation identifiers |
| | name/code (LOINC), actual test results, lab |
| | value, normal range) |
| | Sensitive information may be excluded |
| | Lag time of data: up to 30 days based on |
| | claims data |
| Patient Admission/ | Reflects hospital admissions/readmissions for |
| Readmission Summary | member in the last 12 months, as available |
| | (facility name, city, and state, admitting |
| | diagnosis code, description of diagnosis |
| | code, admission date, discharge diagnosis |
| | code, readmission indicator y/n) |
| | A readmission is defined as an admission |
| | within 30 days of a previous admission |
| | regardless of the diagnosis code |
| | Y indicates that the admission is considered |
| | a readmission |
| | N indicates that the admission is a new |
| | admission for this patient |
| | Lag time of data: up to 30 days based on |
| | claims data |

The member summary assists health care providers in improving clinical outcomes and reinforcing member behaviors in the areas of disease management/preventative care by reducing the volume of information providers must review prior to, or during, a meeting with the member/patient to gain the same clinically relevant insights. The member summary further creates and supports efficiencies that highlight HEDIS/STARs measures compliance, Medicare Risk Adjustment risk score reduction, and patient readmission avoidance. Because access to the summary is integrated into existing provider practice workflows, providers are more likely to use the member summary in connection with patient visits. In an example embodiment, the member summary is accessible from eligibility and benefits screens through an insurance company provider portal or partner portal. Additionally, print and print to file functionality is provided as well as rules for how to display the data. Members may further be given an opportunity to opt-in or opt-out of the member summary process.

Appendix A comprises a list of business rules for selecting data for member summary. One of skill in the art would understand that various aspects of business rules may be modified according to the needs of a payer and its member patients and still fall within the scope of the claimed invention. Additional, data selected for a member summary as well as formatting and presentation of data on a member summary may be modified according to the needs of a payer and its member patients and fall within the scope of the claimed invention.

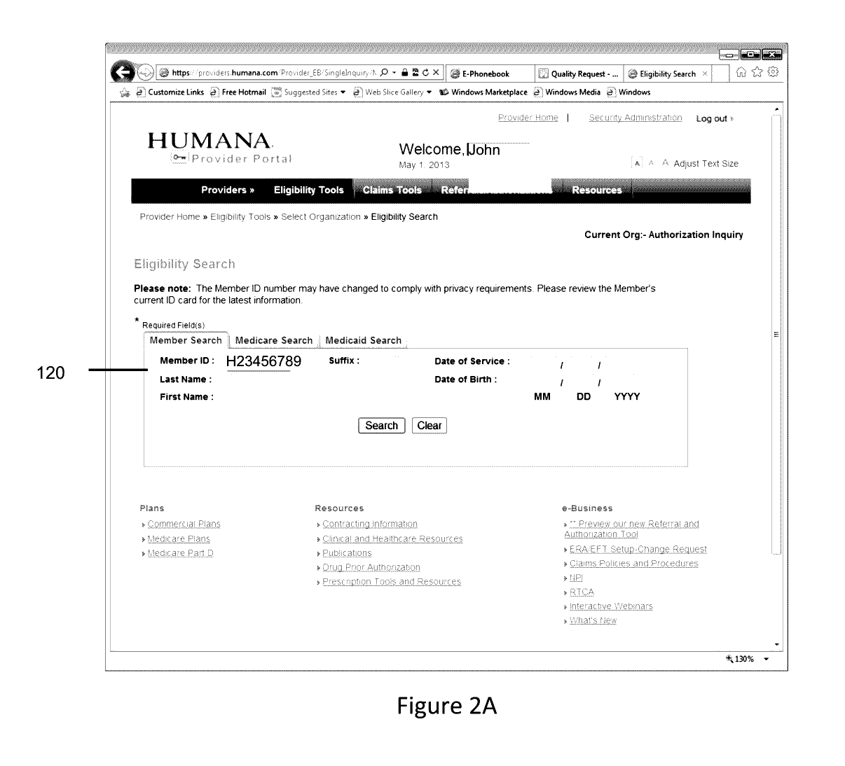

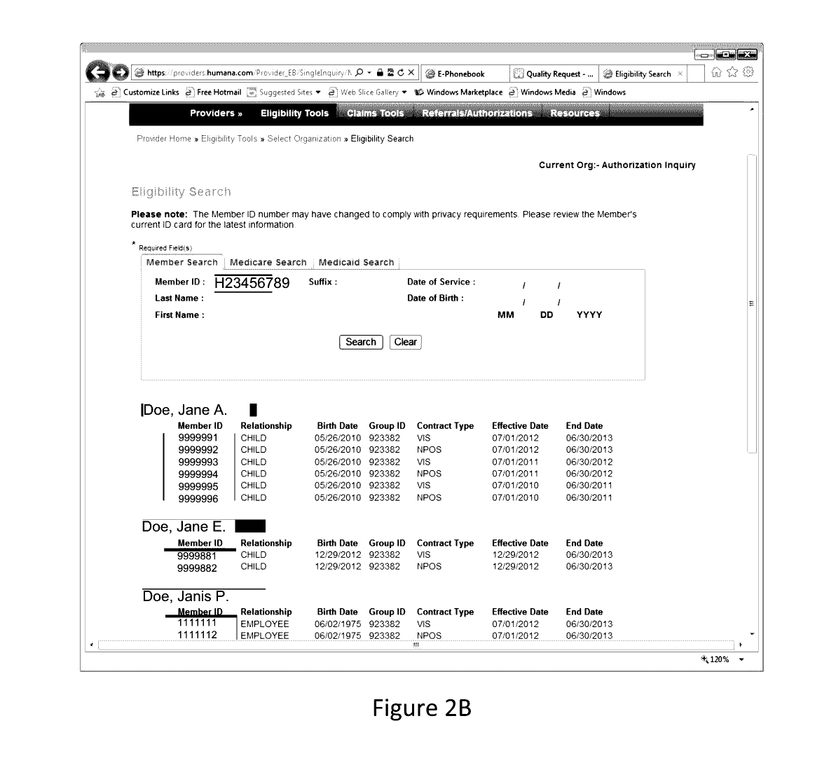

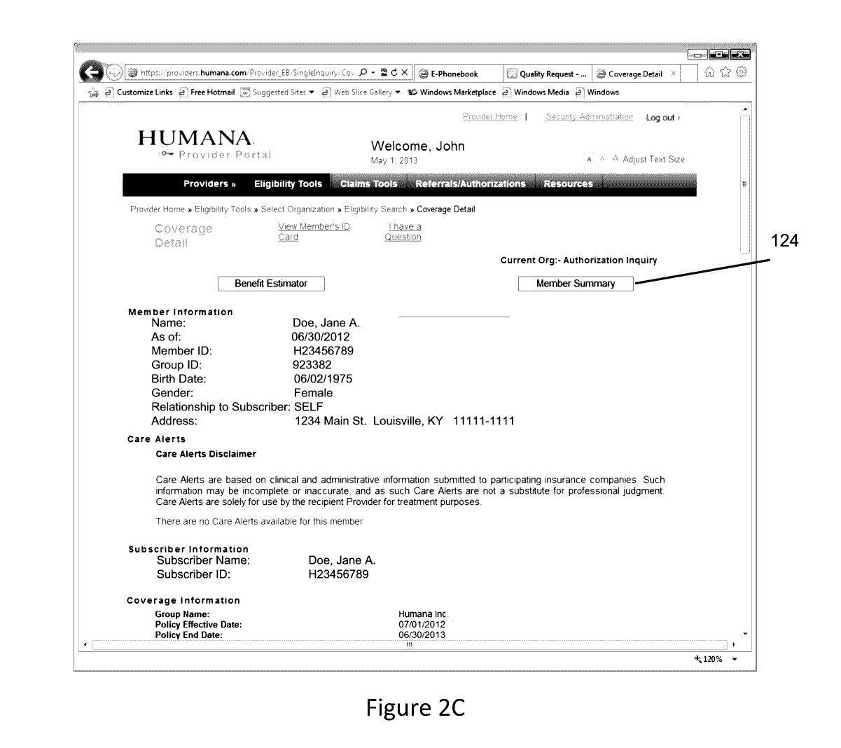

Referring to FIGS. 2A-2C, sample member summary access screens for a payer provider portal according to an example embodiment are shown. In an example embodiment, access to the member summary is integrated into the health care provider's practice workflow. When consulting with patients during office visits or consultations, a health care provider typically performs an eligibility and benefits check for an insured's benefits. Referring to FIG. 2A, a sample eligibility screen is shown. The provider enters member identifying information such as the member's member identifier and/or name 120. Referring to FIG. 2B, a sample search results screen is shown. The screen comprises a list of members that meet the specified search criteria. Identifying data for each member meeting the search criteria is displayed. In addition to displaying information about each individual linked to the member identifying data, a link to a member summary for the individual is provided 122.

Referring to FIG. 2C, a sample coverage detail screen according to an example embodiment is shown. This screen may also be accessed through a provider portal. The screen comprises identifying information for the member and details of the member's benefits and coverage as well as a link to the member summary 124.

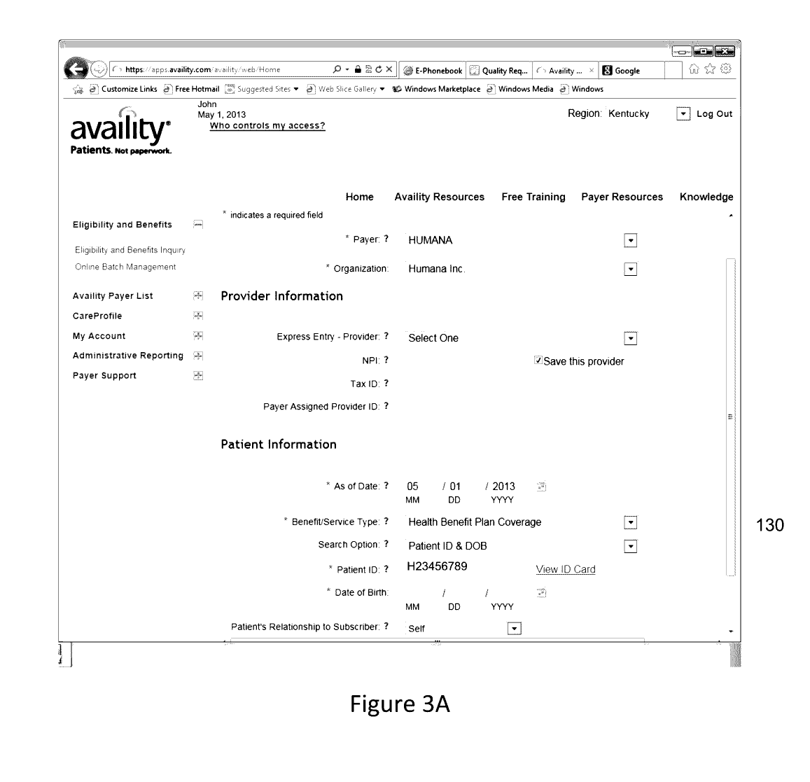

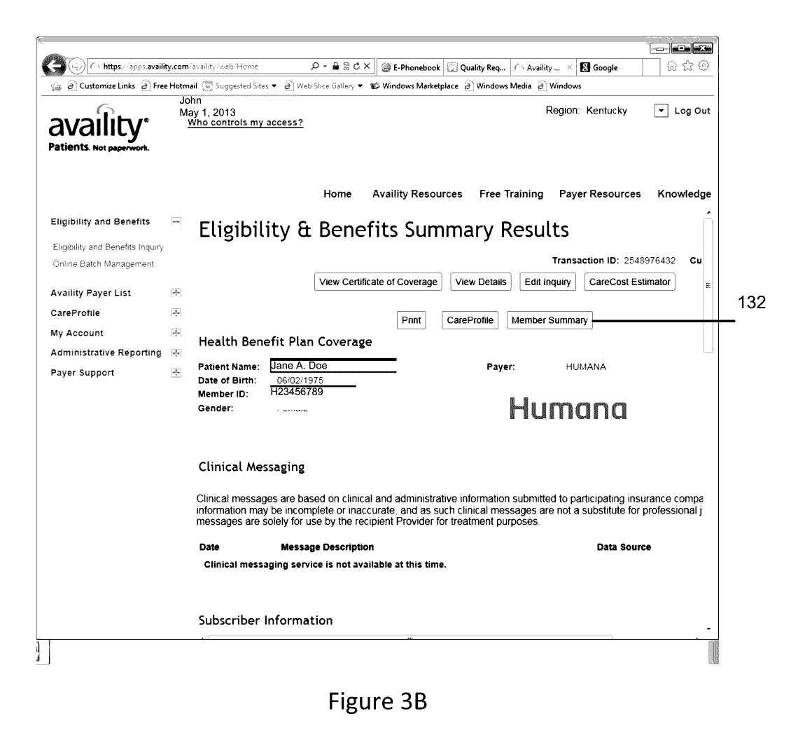

Referring to FIGS. 3A and 3B, sample member summary access screens for a payer partner portal according to an example embodiment are shown. A payer partner may provide administrative and other services to a primary payer such as an insurance company. Referring to FIG. 3A, after accessing the portal, the provider enters identifying data for the member 130 to access eligibility and benefits information for the member. Referring to FIG. 3B, a sample eligibility and benefits summary results screen is shown. The screen comprises a “member summary” option 132 that allows the provider to access the member summary.

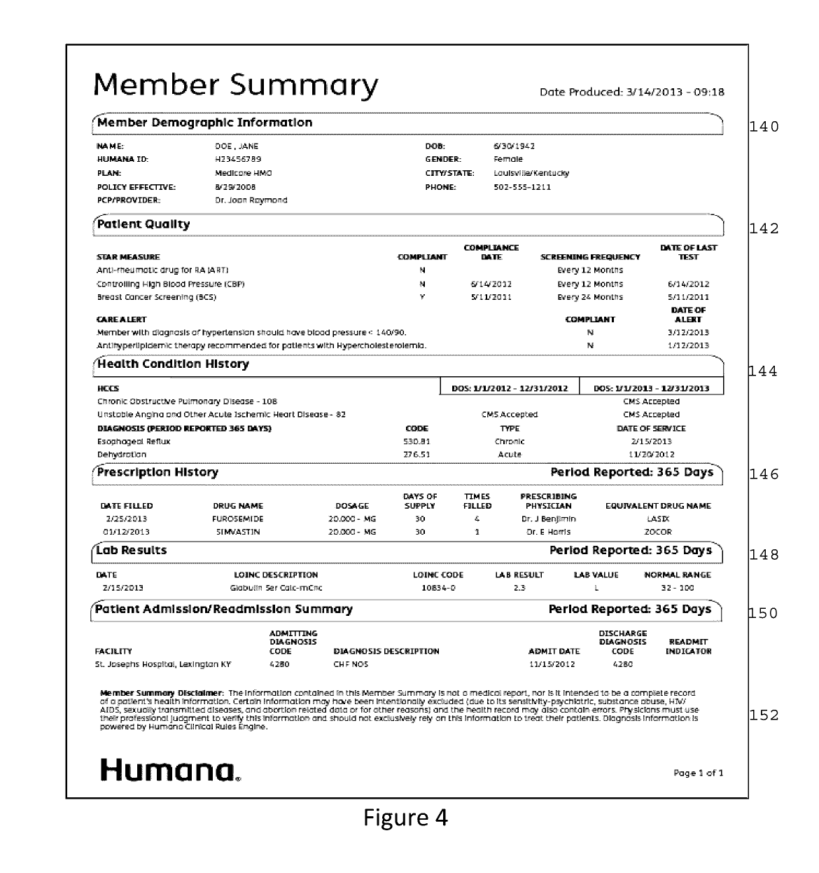

Referring to FIG. 4 a sample member summary for a member covered under a Medicare plan for an example embodiment is shown. Referring to FIG. 4, a summary according to an example embodiment comprises a member demographic information section 140, a patient quality section 142, a health conditions history section 144, a prescription history section 146, a lab results section 148, and a patient admission/readmission summary section 150. The member summary further comprises a disclaimer 152.

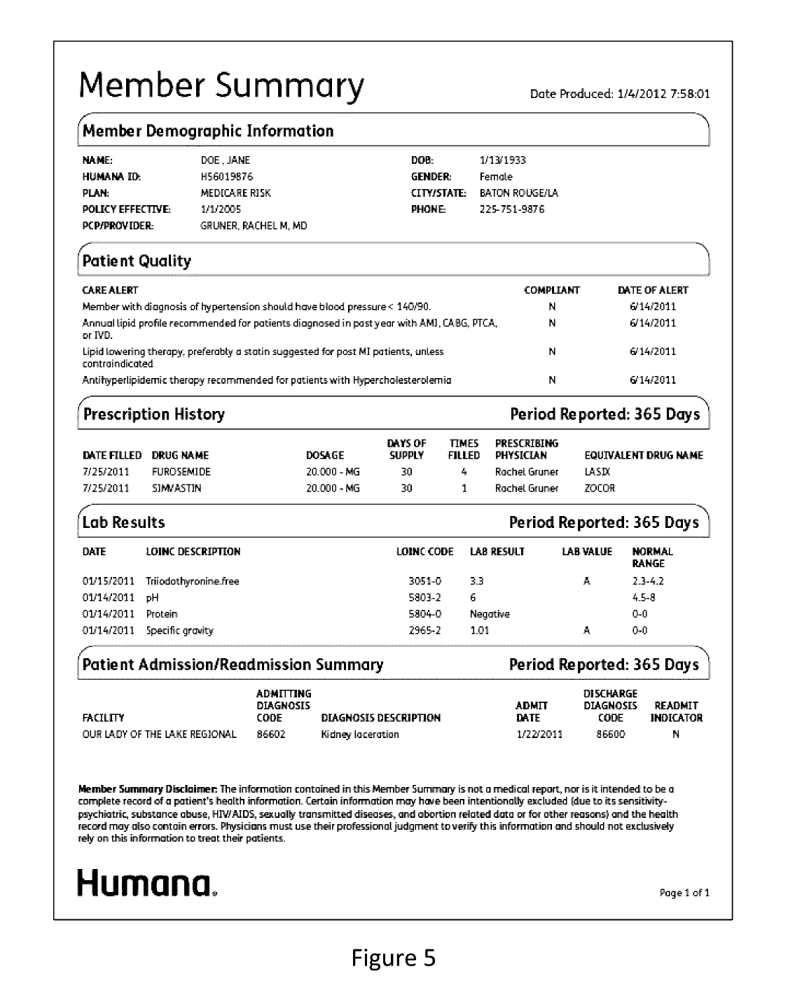

FIG. 5 is a sample summary for members covered under a commercial plan.

In an example embodiment, multiple member summaries may be produced in bulk through a single transaction via a batch capability feature. The ability to produce multiple member summaries improves office workflow efficiencies. In an example embodiment, the batch capability may be implemented as a provider portal option that allows a provider practice to produce member summaries for multiple patients in one transaction. In an example embodiment, a provider submits a standardized request with the following items: member identifier; member date of birth; provider name; provider tax identifier; an optional provider practice name; and an optional member appointment date.

A member summary for each member identified in the request is produced and transmitted to the provider in a secure manner (e.g., PDF format). Individual member summaries are identified on the file received by the provider according to the member's identifier, date of birth, and first and last name. The member summaries in the file transmitted to the provider are grouped as provided in the standardized request. Upon receipt of the file, the provider may view, print, and/or save each individual member summary. In addition, the provider may save the entire master file (e.g., zip file) for processing and distribution at a later time. Additionally, the file transmitted to the provider comprises a status field indicating if each member summary requested was produced, generated an error, was not eligible, etc. The availability of on-demand production of a member summary is not disrupted by batch production of member summaries.

Providers may take advantage of the batch capability in different ways. For example, a provider may submit a request to produce multiple member summaries in a single transaction for patients who have an appointment in the upcoming week. The provider may submit a request for multiple member summaries simultaneously via a standardized request and receives a file via a batch transaction containing the individual member summaries as requested. A provider practice may request multiple member summaries for multiple providers according to the dates of the patients' appointments. A member summary file is then transmitted to the provider sorted by provider and appointment date.

Member summaries according to the present disclosure may be integrated into Electronic Medical Records (EMR) to facilitate clinical HL7 connections between providers and a payer. Pertinent clinical information may be delivered to a provider to be used at point of care to assist in identifying actionable opportunities for improving clinical outcomes and reducing medical costs. In an example embodiment, the member summary is embedded into an industry standard and interoperable HITSP C32 which can be viewed and partially imported, if determined by the provider, to allow for select aspects to be uploaded in a structured manner into the EMR.

The disclosed computerized system and method for generating and presenting a member summary provides benefits to health care providers as well as their patients. The member summary focuses interactions between health care providers and patients on important elements of the patient's health condition and further identifies additional actionable opportunities that can lead to improved clinical outcomes for patients. For the payer, there are potential reductions in medically-related costs. In an example embodiment, access to the member summary is leveraged through an existing process in which a member's eligibility and benefits status is verified through a payer provider portal or payer partner provider portal. Integration of the member summary into a provider's practice workflow increases the likelihood that providers will access and use the summary during office visits and consultations. Information on the summary is derived from a comprehensive, multi-provider claims history but is limited to current and clinically relevant information. It leverages existing payer data sources to the benefit of health care providers and their patients. It may be accessed online, printed, or saved and placed in the member's chart/medical record for review and discussion between the providers and the members at the time of care.

While certain embodiments of the disclosed computerized system and method are described in detail above, the scope of the invention is not to be considered limited by such disclosure, and modifications are possible without departing from the spirit of the invention as evidenced by the claims. For example, elements of the user interface may be varied and fall within the scope of the claimed invention. Various aspects of data collection and presentation may be varied and fall within the scope of the claimed invention. One skilled in the art would recognize that such modifications are possible without departing from the scope of the claimed invention.

### APPENDIX A

### Member Summary Business Rules

### MEMBER DEMOGRAPHIC INFORMATION:

Policy Effective Date: actual start date of the member's policy
If no data is returned for display in any of the following three fields, display message ‘No information available at this time’ and do not display Member Summary:
   Name
   Date of Birth
   Policy or Plan Identifier

### PATIENT QUALITY:

Section displays for Medicare members based on the member's plan designation (as returned in the Member Demographic Information section)
If member is “Commercial,” display care alerts
STAR Measures with COMPLIANCE INDICATOR of ‘N’ display before those with COMPLIANCE INDICATOR of ‘Y’ based on:
   All STAR Measures with indicator of ‘N’ displayed based on hierarchy order
   All STAR Measures with indicator of ‘Y’ displayed next, based on hierarchy order

### 2012 HEDIS STAR Hierarchy

| Rank | STAR Measure Acronym | STAR Measure Description |
|---|---|---|
| 1 | CDC-LDL Controlled | Comprehensive Diabetes Care |
| | | (Cholesterol Controlled LDL <100) |
| 2 | CDC-HbA1C | Comprehensive Diabetes Care |
| | | (Blood Sugar Controlled HbA1c >9)) |
| 3 | CDC-LDL Test | Cholesterol LDL Screening |
| | | (Patients with Diabetes) |
| 4 | CDC - Eye Exam | Comprehensive Diabetes Care |
| | | (Eye Exam) |
| 5 | CDC - Neph | Comprehensive Diabetes Care (Kidney |
| | | Disease Monitoring) |
| 6 | AAP | Adults' Access to Preventive/ |
| | | Ambulatory Health Services |
| 7 | ABA (BMI) | Adult BMI Assessment |
| 8 | ART | Anti-Rheumatic Drug Therapy for |
| | | Rheumatoid Arthritis |
| 9 | BCS | Breast Cancer Screening |
| 10 | CMC | Cholesterol LDL Screening |
| | | (Patients with Cardiovascular |
| | | Conditions) |
| 11 | COA - Functional Status | Care for Older Adults - Functional |
| | Assessment | Status Assessment |
| 12 | COA - Medication | Care for Older Adults - Medication |
| | Review | Review |
| 13 | COA-Pain Screening | Care for Older Adults - Pain Screening |
| 14 | COL | Colorectal Cancer Screening |
| 15 | GSO | Glaucoma Screening in Older Adults |
| 16 | OMW | Osteoporosis Management in Women |
| | | Who Had a Fracture |
| 17 | CBP | Controlling High Blood Pressure |

CMS Medicare approved STAR Measures display
If no data is returned for display in any of the following fields, no line for that Star Measure is displayed:
   Star Measure
   Compliant
   Compliance Date
   Screening Frequency
   Date of Last Test

### Health Condition History:

HEALTH CONDITION HISTORY section displays for Medicare members based on the member's policy or plan
If member is “commercial,” suppress HEALTH CONDITION HISTORY section
Limit the number of lines for HCCs displayed to 25 lines.
HCC ‘Status’ values map to two standard statuses:
   Values >50 map to ‘CMS Accepted’
   Values<51 map to ‘Review Requested’

### HCC Status Values and Descriptions:

### “Review Requested”

| Value | Status |
|---|---|
| 1 | OPEN |
| 11 | OPEN/CMS ACC 1st PRIOR PERIOD |
| 12 | OPEN/CMS ACC 2nd PRIOR PERIOD |
| 21 | PROVIDER CONTACTED |
| 22 | ACTION REQUESTED |
| 23 | ACTION REQUESTED REVIEWED |
| 31 | PROVIDER AFFIRMED CONDITION |
| 32 | PROVIDER DENIED CONDITION |
| 33 | SUSPECT CONDITION EXPIRED |
| 45 | PAYER DELETED |

### “CMS Accepted”

| Value | Status |
|---|---|
| 51 | CMS ACCEPTED, NO PROVIDER CONTACT |
| 52 | CMS ACCEPTED, PROVIDER CONTACTED |
| 53 | CMS ACCEPTED, NO SUSPECT STATUS |
| 54 | CMS CANCELLED |
| 55 | CMS ACCEPTED, NOT SUBMITTED BY PAYER |
| 56 | CMS ACCEPTED, ACTION REQUESTED |

Display HCCs that have a status of ‘CMS Accepted’(up to 25 lines).
If the data in the Health Condition History section has been truncated, display a message in a banner below the lines stating “Additional information is available but could not be displayed”
For Medicare members who do not have any HCC data to report, display two asterisks (**) in the field under HCC subheading
   Risk Score displays if that data is returned
If no data is returned for Risk Score field, display two asterisks (**) in the field
If HCC Description is not returned, do not display the line for that HCC

### Prescription History:

If the “Times Filled” field contains a value of ‘0’, change the value to ‘1’
If a different prescribing physician writes a prescription for the same drug, show it as a separate line item
Prescriptions for a drug that a member is already taking but prescribed with a different dosage, display it as a separate line item
If prescribed “Drug Name” is the same as an “Alternate Drug Name” on an existing line item, or vice versa, display it as a separate line item
If no data is returned for “Drug Name,” do not display the line
If National Drug Code (NDC) is returned instead of the Drug Name, display the line

### Lab Results:

Display the most recently completed tests first.
If no information is returned for LOINC Code and LOINC Description fields, do not display the line
If default code of 99999-9 appears in the LOINC Code field, do not display the line
If no data is returned for display in the following fields display 2 asterisks (**) in the field:
   Lab Result
   Lab Value
   Normal Range

### Patient Admission/Readmission:

A readmission is a consecutive, acute care hospital admission where the time between discharge from the first hospitalization and admission for the second acute care hospitalization is less than or equal to 30 days
If member has hospital admissions that meet the requirement to be considered a Readmission, then display ‘Y’ in the Readmission in the indicator column for the second hospitalization. Otherwise display ‘N’.

### Common Rules:

Member summary is a maximum of three pages
   If Member summary data display exceeds three pages, limit Prescription History section to 15 lines
   If Member summary still exceeds three pages after limiting Prescription History section, then limit Patient Admission/Readmission Summary section to 15 lines
   If Member summary still exceed three pages after limiting Prescription History section and Patient Admission/Readmission Summary section, then limit the Lab Results section to the number of lines that do not exceed three pages with most recently completed tests first
If any section has been truncated, display a message in a banner below the lines of the section stating “Additional information is available but could not be displayed”
Member Name, policy or plan identifier, and Date of Birth (DOB) display in one line at the top of consecutive pages after the first page (e.g., Smith, John, H23456789, Jan. 1, 2011)
If data from any section of the Member summary goes to the next page, the column headers also display on the next page
If no information is provided from Data Aggregation for any one section of the Member summary (for Commercial member vs. Medicare member section rules are defined above under specific sections), display a message in a banner across all columns of the section stating “No information is available for this member at this time”
If the requested Humana Member Summary cannot be delivered due to system problems, display a message stating ‘We are unable to produce the Member Summary at this time. Please try again later’ Date and Time (HH:MM:SS) is auto populated on the upper right corner after

Member Summary heading
Disclaimer displays on the first page of the Humana Member Summary
Page numbers display at the bottom of the printed page. Member Summary pages are identified as ‘Page 1 of 3’ etc. as appropriate for the number of pages
If a requested member has opted out, a message stating ‘Member has elected not to share their clinical information at this time’ is displayed and no Member Summary is provided
If requested member does not have an active policy or plan, a message stating ‘This member is not eligible for Member Summary’ is displayed
If two asterisks (**) have been displayed on a page of the Member Summary, display a legend at the bottom of that page above the Disclaimer stating ‘**=Not Available”

1. A computerized method for presenting payer-based health record data to a health care provider comprising:
(a) generating at a server for display at a health care provider portal a display screen prompting a computer user to search for a member of a health plan;
(b) receiving at said server member search criteria for at least one member of said health plan;
(c) searching at least one payer-based health record database based on said member search criteria to locate payer-based health record data for said at least one member;
(d) applying rules to said payer-based health record data for said at least one member to identify member health summary data comprising:
(1) patient quality data comprising:
(i) at least one care measure indicating compliance with a medical screening applicable to said member; and
(ii) at least one care alert indicating a gap in care applicable to said member;
(2) health condition data identifying at least one diagnosed health condition for said member;
(3) prescription data for said member;
(4) lab results data for said member; and
(5) health care facility admission data for said member;
(e) providing a batch capability for producing a plurality of member summaries for a plurality of members matching said member search criteria in bulk and generating at said server for display at said health care provider portal a display screen comprising:
(1) member identifying data for said plurality of members matching said member search criteria;
(2) member coverage data for said health plan for each of said plurality of members; and
(3) a plurality of hyperlinks to member health summaries comprising said member health summary data for each of said plurality of members;
(f) receiving at said server a selection of one of said plurality of hyperlinks to access said member health summary; and
(g) generating at said server for display at said health care provider portal a member health summary web page comprising:
(1) member identifying data for a member associated with said selected hyperlink; and
(2) said member health summary data for said member associated with said selected hyperlink.

2. The computerized method of claim 1 wherein said at least one care measure indicating compliance with at least one medical screening comprises a compliance indicator indicating whether said screening has been completed according to a recommended frequency.

3. The computerized method of claim 1 wherein said prescription data comprises:
(a) identifying data for at least one prescription; and
(b) dosage, days of supply, and times filled values for said at least one prescription.

4. The computerized method of claim 1 wherein said lab results data comprises:
(a) identifying data for at least one lab test; and
(b) at least one value for said at least one lab test and a normal range for said at least one value.

5. The computerized method of claim 1 wherein said health care facility admission data comprises:
(a) identifying data for a health care facility;
(b) admitting diagnosis data; and
(c) an admission date.

6. The computerized method of claim 5 wherein said admitting diagnosis data comprises an admitting diagnosis code and a diagnosis description.

7. The computerized method of claim 5 wherein said health care facility admission data further comprises a readmission indicator indicating whether an admission occurred within a specified time period of a prior admission.

8. The computerized method of claim 1 wherein said member health summary further comprises health condition history data for said plurality of members.

9. A computerized system for presenting payer-based health record data to a health care provider comprising:
(a) at least one computerized payer-based health record database; and
(b) a server executing instructions to:
(1) generate for display at a health care provider portal a display screen prompting a computer user to search for a plurality of members of a health plan;
(2) receive member search criteria for said plurality of members of said health plan;
(3) search said at least one payer-based health record database based on said member search criteria to locate payer-based health record data for said plurality of members;
(4) apply rules to said payer-based health record data for said plurality of members to identify member health summary data comprising:
(i) patient quality data comprising:
(A) at least one care measure indicating compliance with a medical screening applicable to each of said plurality of members; and
(B) at least one care alert indicating a gap in care applicable to each of said plurality of members;
(ii) health condition data identifying at least one diagnosed health condition for each of said plurality of members;
(iii) prescription data for each of said plurality of members;
(iv) lab results data for each of said plurality of members; and
(v) health care facility admission data for each of said plurality of members;
(5) generate for display at said health care provider portal a display screen comprising:
(i) member identifying data for each of said plurality of members matching said member search criteria;
(ii) member coverage data for said health plan; and
(iii) a plurality of hyperlinks to a member health summary comprising said member health summary data for each of said plurality of members;
(6) receive a selection of said hyperlinks to access said member health summary for each of said plurality of members; and
(7) generate for display at said health care provider portal a member health summary web page comprising:
(i) member identifying data for each of said plurality of members; and
(ii) said member health summary data for each of said plurality of members.

10.-12. (canceled)

13. The computerized system of claim 9 wherein said health care facility admission data comprises:
(a) identifying data for a health care facility;
(b) admitting diagnosis data; and
(c) an admission date.

14. The computerized system of claim 13 wherein said admitting diagnosis data comprises an admitting diagnosis code and a diagnosis description.

15. The computerized system of claim 13 wherein said health care facility admission data further comprises a readmission indicator indicating whether an admission occurred within a specified time period of a prior admission.

16.-25. (canceled)

26. A system for searching and providing payer-based health record data to a health care provider comprising:
at least one data source comprising health data for members of a health plan;
a portal comprising a graphical user interface having a search area for inputting member identifying information for a plurality of members in a single transaction;
a server programmed with one or more software routines executing on the server for:
(a) receiving member identifying information for each of the plurality of members input at said portal;
(b) searching said at least one data source based on said member identifying information to locate payer-based health record data for each of said plurality of members;
(c) providing a batch capability for producing a plurality of member health summaries for each of said plurality of members;
(d) generating at said server for display at said portal a display screen comprising:
(1) member identifying data for each of said plurality of members;
(2) member coverage data for said health plan for each of said plurality of members; and
(3) a plurality of hyperlinks to each of said member health summaries of said plurality of members;
(e) receiving at said server a selection of one of said plurality of hyperlinks;
(f) generating at said server for display at said portal a member health summary associated with said selected hyperlink, comprising:
(1) member identifying data for a member associated with said selected hyperlink; and
(2) member health summary data for said member associated with said selected hyperlink.

27. The system of claim 26, wherein the server is programmed with one or more software routines executing on the server for:
applying rules to said payer-based health record data for said plurality of members to identify member health summary data for each of said plurality of members comprising:
(a) patient quality data comprising:
(1) at least one care measure indicating compliance with a medical screening applicable to each of said plurality of members; and
(2) at least one care alert indicating a gap in care applicable to each of said plurality of members;
(b) health condition data identifying at least one diagnosed health condition for each of said plurality of members;
(c) prescription data for each of said plurality of members;
(d) lab results data for each of said plurality of members; and
(e) health care facility admission data for each of said plurality of members; and
using the member health summary data for each of said plurality of members to generate said member summaries for each of said plurality of members.

28. The system of claim 27, wherein said at least one care measure indicating compliance with a medical screening comprises a compliance indicator indicating whether said screening has been completed according to a recommended frequency.

29. The system of claim 27, wherein said prescription data comprises:
(a) identifying data for at least one prescription; and
(b) dosage, days of supply, and times filled values for said at least one prescription.

30. The system of claim 27, wherein said lab results data comprises:
(a) identifying data for at least one lab test; and
(b) at least one value for said at least one lab test and a normal range for said at least one value.

31. The system of claim 27, wherein said health care facility admission data comprises:
(a) identifying data for a health care facility;
(b) admitting diagnosis data; and
(c) an admission date.

32. The system of claim 27, wherein said admitting diagnosis data comprises an admitting diagnosis code and a diagnosis description.

33. The system of claim 27, wherein said health care facility admission data further comprises a readmission indicator indicating whether an admission occurred within a specified time period of a prior admission.

34. The system of claim 26, wherein the server is programmed with one or more software routines executing on the server for sending a master file with a grouping of the member health summaries to an associated provider.

35. The system of claim 34, wherein the server is programmed with one or more software routines executing on the server for generating a status field in the master file indicating if each member health summary listed in the master file was produced, generated an error, or was not eligible.

36. The system of claim 34, wherein the search area of the graphical interface is configured to accept a provider identification and member appointment date, and wherein the server is programmed with one or more software routines executing on the server for listing the member health summaries by provider and appointment date.

37. The system of claim 34, wherein the server is programmed with one or more software routines executing on the server for integrating said member health summaries into Electronic Medical Records for delivering said member health summaries to providers at a point of care.
